(19) United States
(12) Patent Application Publication
(10) Pub. No.: US 2022/0323859 A1
(43) Pub. Date: Oct. 13, 2022

(54) COMPUTERIZED GAMING SYSTEM AND METHOD OF OPERATING THEREOF

(71) Applicant: Playtech Software Limited, London (GB)

(72) Inventors: Anton GOLOVKO, Tartu (EE); Aleksei LOOS, Tartu (EE); Kaido KEERMA, Tartu (EE); Oleksiy ADAMOV, Kyiv (UA); Eran GILBOA, Gibraltar (GI); Eyal NARKISS, Cliffside Park, NJ (US); Offer BEN MORDECHAI, Gibraltar (GI); Yevhenii STANISHEVSKYI, Kyiv (UA)

(21) Appl. No.: 17/846,759

(22) Filed: Jun. 22, 2022

Related U.S. Application Data
(63) Continuation of application No. 17/078,946, filed on Oct. 23, 2020, now abandoned.
Application No. 17/078,946 is a continuation-in-part of application No. 17/003,415, filed on Aug. 26, 2020.
(60) Provisional application No. 62/891,534, filed on Aug. 26, 2019.
(60) Provisional application No. 62/925,256, filed on Oct. 24, 2019.
(60) Provisional application No. 62/925,256, filed on Oct. 24, 2019.

(51) Int. Cl. A63F 13/35; A63F 13/69

(52) U.S. Cl. CPC A63F 13/35; A63F 13/69

(57) ABSTRACT

In a gaming environment including an aggregation platform, remote game servers (RGS) and Gaming Platform as a Service (GPAS), a method for operating an aggregation platform in a gaming environment. The method including associating a player with tokens and Features, where the tokens are usable to acquire the Features, monitoring operation of the player with the tokens in the games, and determining operation of Features in the games, based upon the operation of the player with the tokens.

### RELATED APPLICATIONS

This application is a continuation of U.S. patent application Ser. No. 17/078,946, filed Oct. 23, 2020, claiming the benefit of continuation-in-part of U.S. patent application Ser. No. 17/003,415 filed Aug. 26, 2020, claiming the benefit of priority to U.S. Provisional Patent Application No. 62/891,534, filed Aug. 26, 2019, and U.S. Provisional Patent Application No. 62/925,256, filed Oct. 24, 2019. The present application also directly claims benefit of U.S. Provisional Patent Application No. 62/925,256, filed Oct. 24, 2019. The entire contents of each of the above-mentioned prior applications are hereby incorporated by reference herein.

### TECHNICAL FIELD

The presently disclosed subject matter relates to computerized gaming systems and more particularly to operating shared Features and states in computerized gaming systems, and methods thereof.

### BACKGROUND

The industry of computerized games is in the process of taking on a new shape, from providing traditional boxed products, toward providing games using service-oriented platforms, in a model of operation referred to as a “Game as a service (GaaS)”. In the GaaS model, the actual game software can be stored on the hosting company's servers and streamed to the player's device as cloud gaming services on a subscription basis of the player. Traditionally, all data relating to the player and the player's activity in the game is stored on the user's computer. The GaaS model, providing cloud gaming services, involves technologies relating to how games are developed, deployed, and maintained, including monitoring a player's activity in the gaming system's level, and providing advanced game functionalities based on the player's activity.

Similar to other cloud computing services, cloud gaming services have many advantages compared to traditional gaming systems, such as scalability, ubiquitous and cross-platform support for providing an immersive gaming experience, cost effectiveness for system development, software distribution, etc. One of the advantages of the GaaS model is that GaaS augments the accessibility of games to players and allows them to play multiple games without installing them. However, this availability involves technological challenges relating to tracking data related to the user's activity during the various games, and consolidating this data at the gaming systems' end. Specifically, the gaming system needs to provide ability to effectively manage users' activity involving real time data tracking and deployment, supporting actions relating to instant approval and distribution of microtransactions, maintain subscription billing, and more.

### GENERAL DESCRIPTION

According to one aspect of the presently disclosed subject matter there is provided a gaming system, comprising:

an aggregation platform operatively communicating with at least one remote game server (RGS), the aggregation platform is configured to operatively communicate with a Gaming Platform as a Service (GPAS), the at least one RGS and the GPAS are configured for hosting a plurality of games to be provided to a plurality of players through players' devices,

wherein the GPAS is further configured for receiving from the aggregation platform data pertaining to tokens balance and/or Features balance, both associated with a player, and to provide the data to the player,

wherein the tokens are usable by the player to acquire one or more Features from a list of available Features, wherein each of the Features has a respective predefined cost value in terms of a number of tokens, and wherein each Feature is operable in one or more of the plurality of games, depending on a Feature's stake value associated with the respective Feature,

wherein the aggregation platform comprising:
a feature shop unit, configured to operatively communicate with the players' devices, and
a token and feature service unit;

with respect to each player of the plurality of players operating a player's device, the aggregation platform is configured to:
by the token and feature service unit, associate the player with a tokens balance comprising one or more tokens and with a Features balance comprising one or more Features, the Features have been acquired by the player, wherein each Feature is associated with a respective Feature's stake value;
transmit the associated tokens balance and the Features balance to the player, through the GPAS;
repeatedly monitor operation of the player, including:
   transmit, by the feature shop unit, the list of available Features to be displayed at the player's device;
   in response to receipt from the at least one RGS or the GPAS data on game events generated the plurality of games, continuously update, by the token and feature service unit, the tokens balance according to a predefined configuration; wherein the updated tokens balance over a selected time interval or portion thereof constitutes a token balance trail;
   receive, by the feature shop unit, a selection of a Feature from the list of available Features, wherein the Feature is operable in at least one game of the plurality of games,
   based on the selection, update, by the token and feature service unit, the tokens balance, by degrading the number of Feature's cost value;
   determine a Feature's stake value of the selected Feature, based on the tokens balance trail, and associate the selected Feature with the determined Feature's stake;
   add the selected Feature, by the token and feature service unit, to the Feature's balance, thereby enabling operation of the selected Feature, according to the feature's stake, and
   transmit the updated Feature balance to the player's device, by the feature shop unit.

In addition to the above features, the method according to this aspect of the presently disclosed subject matter can optionally comprise the following features, in any technically possible combination or permutation:

i. wherein token and feature service unit is further configured to transmit the updated token balance to the player, through the GPAS.

According to another aspect of the presently disclosed subject matter there is provided a method of operating an aggregation platform, comprising:

providing an aggregation platform operatively communicating with at least one remote game server (RGS), the aggregation platform further operatively communicating with a Gaming Platform as a Service (GPAS), the at least one RGS and the GPAS hosting a plurality of games to be provided to a plurality of players through players' devices, wherein the aggregation platform comprising:
a feature shop unit, operatively communicating with the players' devices; and
a token and feature service unit;

wherein the GPAS further receiving from the aggregation platform data pertaining to tokens balance and/or Features balance, both associated with a player, and providing the data to the player,

wherein the tokens are usable by the player to acquire one or more Features from a list of available Features, wherein each of the Features has a respective predefined cost value in terms of a number of tokens, and wherein each Feature is operable in one or more of the plurality of games, depending on a Feature's stake value associated with the respective Feature, the method comprising:

by a processor of the aggregation platform, with respect to each player of the plurality of players:
by the token and feature service unit, associating the player with a tokens balance comprising one or more tokens and with a Features balance comprising one or more Features, the Features have been acquired by the player, wherein each Feature is associated with a respective Feature's stake value;
transmitting the associated tokens balance and the Features balance to the player, through the GPAS;
repeatedly monitoring operation of the player, including:
   transmitting, by the feature shop unit, the list of available Features to be displayed at the player's device;
   in response to receipt from the at least one RGS or the GPAS data on game events generated the plurality of games, continuously updating, by the token and feature service unit, the tokens balance according to a predefined configuration; wherein the updated tokens balance over a selected time interval or portion thereof constitutes a token balance trail;
   receiving, by the feature shop unit, from the player's device, a selection of a Feature from the list of available Features, wherein the Feature is operable in at least one game of the plurality of games,
   based on the selection, updating, by the token and feature service unit, the tokens balance, by degrading the number of Feature's cost value;
   determining a Feature's stake value of the selected Feature, based on the tokens balance trail, and associate the selected Feature with the determined Feature's stake;
   adding the selected Feature, by the token and feature service unit, to the Feature's balance, thereby enabling operation of the selected Feature, according to the feature's stake, and
   transmits the updated Feature balance, by the feature shop unit, to the player's device.

According to another aspect of the presently disclosed subject matter there is provided a method of operating an aggregation platform, comprising:

providing an aggregation platform operatively communicating with at least one remote game server (RGS), the aggregation platform further operatively communicating with a Gaming Platform as a Service (GPAS), the at least one RGS and the GPAS hosting a plurality of games to be provided to a plurality of players, the GPAS is further receiving from the aggregation platform data pertaining to tokens balance and/or one or more states, both associated with a player, and provides the data to the player,

wherein each of the states has a respective predefined value in terms of a number of tokens, and wherein each state is applied in one or more games of the plurality of games, based on a respective state's operational conditions, the method comprising:

by a processor of the aggregation platform, with respect to each player of the plurality of players:
associating the player with a tokens balance comprising one or more tokens;
associating the player with one or more states, based on the respective predefined value, and applying the one or more states in one or more games based on their respective state's operation conditions; and
repeatedly monitoring operation of the player, including:
   in response to receipt from the at least one RGS or the GPAS data on game events generated in the plurality of games, continuously updating the tokens balance according to a predefined configuration, wherein the updated tokens balance over a selected time interval or portion thereof constitutes a token balance trail;
   determining that the updated tokens balance reaching a predefined value of one or more of the states, thereby the one or more states constituting states-to-update;
   determining respective state's operation conditions for each one of the states-to-update, based on the tokens balance trail, and associating each of the one or more states-to-update with the respective determined state's operation conditions; and
   associating the player with the states-to-update.

In addition to the above features, the method according to this aspect of the presently disclosed subject matter can optionally comprise one or more of features (i) to (ii) below, in any technically possible combination or permutation:

i. wherein the method further comprising:

applying the one or more states-to-update in one or more games, based on the associated state's operational conditions;

ii. wherein the method further comprising:

updating the tokens balance, based on the one or more states-to-update, by degrading the respective state predefined value of each one or more states-to-update.

According to another aspect of the presently disclosed subject matter there is provided a gaming system, comprising:

an aggregation platform configured to operatively communicate with at least one remote game server (RGS), the aggregation platform further configured to operatively communicate with a Gaming Platform as a Service (GPAS), the at least one RGS and the GPAS configured to host a plurality of games to be provided to a plurality of players, the GPAS is further configured to receive from the aggregation platform data pertaining to tokens balance and/or one or more states, both associated with a player, and to provide the data to the player,

wherein each of the states has a respective predefined value in terms of a number of tokens, and wherein each state is applied in one or more games of the plurality of games, based on a respective state's operational conditions,

with respect to each player of the plurality of players operating a player's device, the aggregation platform is configured to:
associate the player with a tokens balance comprising one or more tokens;
associate the player with one or more states, based on the respective predefined value, and applying the one or more states in one or more games based on their respective state's operation conditions; and
repeatedly monitor operation of the player, including:
   in response to receipt from the at least one RGS or the GPAS data on game events generated in the plurality of games, continuously update the tokens balance according to a predefined configuration, wherein the updated tokens balance over a selected time interval or portion thereof constitutes a token balance trail;
   determine that the updated tokens balance reaching a predefined value of one or more of the states, thereby the one or more states constituting states-to-update;
   determine respective state's operation conditions for each one of the states-to-update, based on the tokens balance trail, and associating each of the one or more states-to-update with the respective determined state's operation conditions; and
   associate the player with the states-to-update.

According to yet another aspect of the presently disclosed subject matter there is provided a gaming system for operating one or more game Features, comprising:

an aggregation platform configured to operatively communicate with one or more remote game servers (RGS), configured for hosting a plurality of games to be provided to a plurality of players through players' devices,

wherein at least one RGS of the one or more RGS is a designated RGS configured to receive from the aggregation platform data pertaining to tokens balance and/or Features balance, both associated with a player, and to provide the data to the player,

wherein the tokens are usable by the player to acquire one or more Features from a list of available Features, wherein each of the Features has a respective predefined cost value in terms of a number of tokens, and wherein each Feature is operable in a game of the plurality of games, depending on a Feature's stake value associated with the respective Feature,

with respect to each player of the plurality of players operating a player's device, the aggregation platform is configured to:
associate the player with a tokens balance comprising one or more tokens and with a Features balance comprising one or more Features, the Features have been acquired by the player, wherein each Feature is associated with a respective Feature's stake value;
transmit the associated tokens balance and the Features balance to the player, through the designated RGS;
repeatedly monitor operation of the player, including:
   transmit the list of available Features to be displayed at the player's device;
   in response to receipt from the one or more remote game servers (RGS) data on game events generated in the plurality of games, continuously update, the tokens balance according to a predefined configuration; wherein the updated tokens balance over a selected time interval or portion thereof constitutes a token balance trail;
   receive, from the player's device, a selection of a Feature from the list of available Features, wherein the Feature is operable in at least one game of the plurality of games,
   based on the selection, update, the tokens balance, by degrading the number of Feature's cost value;
   determine a Feature's stake value of the selected Feature, based on the tokens balance trail, and associate the selected Feature with the determined Feature's stake;
   add the selected Feature, to the Feature's balance, thereby enabling operation of the selected Feature, according to the feature's stake.

According to another aspect of the presently disclosed subject matter there is provided a method of operating an aggregation platform, comprising:

providing an aggregation platform operatively communicating with one or more remote game servers (RGS) hosting a plurality of games to be provided to a plurality of players through players' devices,

wherein at least one RGS of the one or more RGS is a designated RGS receiving from the aggregation platform data pertaining to tokens balance and/or Features balance, both associated with a player, and to provide the data to the player,

wherein the tokens are usable by the player to acquire one or more Features from a list of available Features, wherein each of the Features has a respective predefined cost value in terms of a number of tokens, and wherein each Feature is operable in a game of the plurality of games, depending on a Feature's stake value associated with the respective Feature, the method comprising:

by a processor of the aggregation platform, with respect to each player of the plurality of players:
associating the player with a tokens balance comprising one or more tokens and with a Features balance comprising one or more Features, the Features have been acquired by the player, wherein each Feature is associated with a respective Feature's stake value;
transmitting the associated tokens balance and the Features balance to the player, through the designated RGS;
repeatedly monitoring operation of the player, including:
   transmitting the list of available Features to be displayed at the player's device;
   in response to receipt from the one or more remote game servers (RGS) data on game events generated in the plurality of games, continuously updating, the tokens balance according to a predefined configuration; wherein the updated tokens balance over a selected time interval or portion thereof constitutes a token balance trail;
   receiving, from the player's device, a selection of a Feature from the list of available Features, wherein the Feature is operable in at least one game of the plurality of games,
   based on the selection, updating, the tokens balance, by degrading the number of Feature's cost value;
   determining a Feature's stake value of the selected Feature, based on the tokens balance trail, and associate the selected Feature with the determined Feature's stake;

adding the selected Feature, to the Feature's balance, thereby enabling operation of the selected Feature, according to the feature's stake.

According to another aspect of the presently disclosed subject matter there is provided a non-transitory computer readable storage medium tangibly embodying a program of instructions that, when executed by a computer, cause the computer to perform a method of operating an aggregation platform, comprising:

providing an aggregation platform operatively communicating with at least one remote game server (RGS), the aggregation platform further operatively communicating with a Gaming Platform as a Service (GPAS), the at least one RGS and the GPAS hosting a plurality of games to be provided to a plurality of players through players' devices, wherein the aggregation platform comprising:
a feature shop unit, operatively communicating with the players' devices; and
a token and feature service unit;

wherein the GPAS further receiving from the aggregation platform data pertaining to tokens balance and/or Features balance, both associated with a player, and providing the data to the player,

wherein the tokens are usable by the player to acquire one or more Features from a list of available Features, wherein each of the Features has a respective predefined cost value in terms of a number of tokens, and wherein each Feature is operable in one or more of the plurality of games, depending on a Feature's stake value associated with the respective Feature, the method comprising:

by a processor of the aggregation platform, with respect to each player of the plurality of players:
by the token and feature service unit, associating the player with a tokens balance comprising one or more tokens and with a Features balance comprising one or more Features, the Features have been acquired by the player, wherein each Feature is associated with a respective Feature's stake value;
transmitting the associated tokens balance and the Features balance to the player, through the GPAS;
repeatedly monitoring operation of the player, including:
   transmitting, by the feature shop unit, the list of available Features to be displayed at the player's device;
   in response to receipt from the at least one RGS or the GPAS data on game events generated the plurality of games, continuously updating, by the token and feature service unit, the tokens balance according to a predefined configuration; wherein the updated tokens balance over a selected time interval or portion thereof constitutes a token balance trail;
   receiving, by the feature shop unit, from the player's device, a selection of a Feature from the list of available Features, wherein the Feature is operable in at least one game of the plurality of games,
   based on the selection, updating, by the token and feature service unit, the tokens balance, by degrading the number of Feature's cost value;
   determining a Feature's stake value of the selected Feature, based on the tokens balance trail, and associate the selected Feature with the determined Feature's stake;
   adding the selected Feature, by the token and feature service unit, to the Feature's balance, thereby enabling operation of the selected Feature, according to the feature's stake, and
   transmits the updated Feature balance, by the feature shop unit, to the player's device.

According to another aspect of the presently disclosed subject matter there is provided a non-transitory computer readable storage medium tangibly embodying a program of instructions that, when executed by a computer, cause the computer to perform a method of operating an aggregation platform, comprising:

providing an aggregation platform operatively communicating with at least one remote game server (RGS), the aggregation platform further operatively communicating with a Gaming Platform as a Service (GPAS), the at least one RGS and the GPAS hosting a plurality of games to be provided to a plurality of players, the GPAS is further receiving from the aggregation platform data pertaining to tokens balance and/or one or more states, both associated with a player, and provides the data to the player,

wherein each of the states has a respective predefined value in terms of a number of tokens, and wherein each state is applied in one or more games of the plurality of games, based on a respective state's operational conditions, the method comprising:

by a processor of the aggregation platform, with respect to each player of the plurality of players:
associating the player with a tokens balance comprising one or more tokens;
associating the player with one or more states, based on the respective predefined value, and applying the one or more states in one or more games based on their respective state's operation conditions; and
repeatedly monitoring operation of the player, including:
   in response to receipt from the at least one RGS or the GPAS data on game events generated in the plurality of games, continuously updating the tokens balance according to a predefined configuration, wherein the updated tokens balance over a selected time interval or portion thereof constitutes a token balance trail;
   determining that the updated tokens balance reaching a predefined value of one or more of the states, thereby the one or more states constituting states-to-update;
   determining respective state's operation conditions for each one of the states-to-update, based on the tokens balance trail, and associating each of the one or more states-to-update with the respective determined state's operation conditions; and
   associating the player with the states-to-update.

According to another aspect of the presently disclosed subject matter there is provided a non-transitory computer readable storage medium tangibly embodying a program of instructions that, when executed by a computer, cause the computer to perform a method of operating one or more game Features, comprising:

providing an aggregation platform operatively communicating with one or more remote game servers (RGS) hosting a plurality of games to be provided to a plurality of players through players' devices,

wherein at least one RGS of the one or more RGS is a designated RGS receiving from the aggregation platform data pertaining to tokens balance and/or Features balance, both associated with a player, and to provide the data to the player,

wherein the tokens are usable by the player to acquire one or more Features from a list of available Features, wherein each of the Features has a respective predefined cost value in terms of a number of tokens, and wherein each Feature is operable in a game of the plurality of games, depending on a Feature's stake value associated with the respective Feature, the method comprising:

by a processor of the aggregation platform, with respect to each player of the plurality of players:
associating the player with a tokens balance comprising one or more tokens and with a Features balance comprising one or more Features, the Features have been acquired by the player, wherein each Feature is associated with a respective Feature's stake value;
transmitting the associated tokens balance and the Features balance to the player, through the designated RGS;
repeatedly monitoring operation of the player, including:
   transmitting the list of available Features to be displayed at the player's device;
   in response to receipt from the one or more remote game servers (RGS) data on game events generated in the plurality of games, continuously updating, the tokens balance according to a predefined configuration; wherein the updated tokens balance over a selected time interval or portion thereof constitutes a token balance trail;
   receiving, from the player's device, a selection of a Feature from the list of available Features, wherein the Feature is operable in at least one game of the plurality of games,
   based on the selection, updating, the tokens balance, by degrading the number of Feature's cost value;
   determining a Feature's stake value of the selected Feature, based on the tokens balance trail, and associate the selected Feature with the determined Feature's stake;
   adding the selected Feature, to the Feature's balance, thereby enabling operation of the selected Feature, according to the feature's stake.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 shows a high-level illustration of a computerized gaming environment 100 in accordance with certain embodiments of the presently disclosed subject matter;

FIG. 2 illustrates a high-level functional block diagram of several entities in the gaming environment, in accordance with certain embodiments of the presently disclosed subject matter;

FIG. 3 illustrates a generalized diagram of feature acquisition flow, in accordance with certain embodiments of the presently disclosed subject matter;

FIG. 4 illustrates a general flowchart of operations performed by platform 101 in order to operate shared Features, in accordance with certain embodiments of the presently disclosed subject matter;

FIG. 5 illustrates a high-level functional block diagram of several entities in the gaming environment configured to operate shared States, in accordance with certain embodiments of the presently disclosed subject matter; and

FIG. 6 illustrates a general flowchart of operations performed by platform 101 in order to operate shared States, in accordance with certain embodiments of the presently disclosed subject matter.

### DETAILED DESCRIPTION

As apparent from the following discussions, and unless specifically stated otherwise, it is appreciated that throughout the specification discussions utilizing terms such as “providing”, “communicating”, “hosting”, “using”, “acquiring”, “associating”, “transmitting”, “monitoring”, “updating”, “calculating”, “using”, “transmitting”, “generating”, “adding”, “maintaining”, “receiving”, “operating”, “displaying”, “determining”, “enabling”, “applying”, “degrading”, “sending”, “pressing”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the gaming system disclosed in the present application.

The operations in accordance with the teachings herein may be performed by a computer specially constructed for the desired purposes, or by a general-purpose computer specially configured for the desired purpose by a computer program stored in a non-transitory computer-readable storage medium.

According to certain embodiments of the presently disclosed subject matter, gaming environments involve a large number of separate entities, operating and communicating through a complex network and architecture. Content, such as games, are created by a content creator or content provider, and are stored on Remote Gaming Servers (RGSs) around the world. A game can be stored on more than one RGS. A licensee of a casino, also to be referred to herein as an operator, can choose to operate one or more games by adding them to the operator's portfolio, while the games themselves are stored on a single RGS or multiple RGSs. Operation of the games is subject to various dynamic parameters and configurations, some of which are dictated by local legislation and some being determined or structured by the content creator, the licensee operator, or the RGS itself. In addition, the games can communicate with external systems, such as backend and management systems of the licensee operators, player management systems, various analytic systems, and wallet management systems. In order to provide GaaS mode of operation in a smooth manner, a gaming system needs to constantly track a player's activity during the various games and provide the required gaming functionalities. As such, there is a constant communication of data pertaining to the content stored on a particular RGS, e.g. the games, between entities operating in the network.

Tracking the user's activity in several games hosted by RGSs, and aggregating the data at a higher level than the RGSs hosting the particular games, enables the entity that aggregates the data, to provide additional services to the player, which may be spread to several games, e.g. to games belonging to a specific suit of games. Also, the data gathered in one game, including the user activity and betting in one game, can be used to provide services in another game, or provide advanced services to game operators.

According to certain embodiments of the presently disclosed subject matter, the gaming system can provide the player with Features, e.g. in-game options and/or out-game options, to be operated in games, based on the player's activity in other games. In order to do so, the gaming system can monitor and aggregate data pertaining to the player's activity in one or more games hosted by RGSs. The aggregated data includes data on game events generated in the games. Based on the aggregated data, the gaming system can determine how to operate a Feature that is provided to the player.

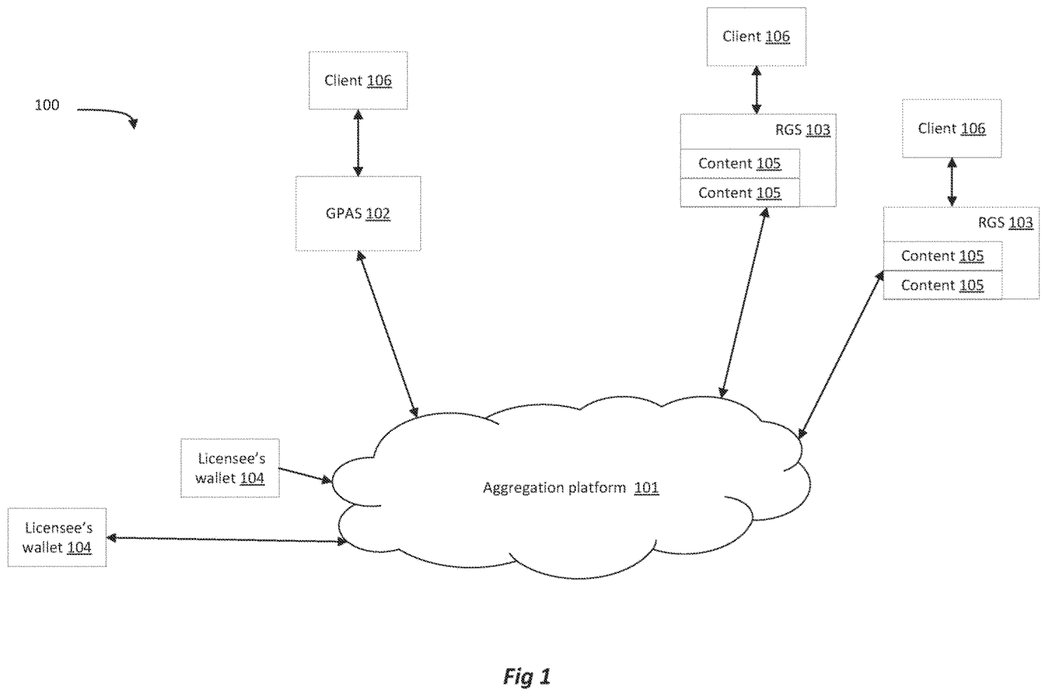

Bearing this in mind, attention is drawn to FIG. 1 illustrating a generalized diagram of a computerized gaming environment 100 in accordance with certain embodiments of the currently presented subject matter.

An aggregation platform 101 is operatively connected to one or more Remote Gaming Servers (RGSs) 103 each hosting one or more content pieces 105, e.g. games. The aggregation platform 101 is also operatively connected to one or more additional RGSs, denoted by GPAS 102, configured in accordance with certain embodiments of the currently presented subject matter. The aggregation platform 101 is further operatively connected to several instances of licensee's wallet systems denoted as 104.

In some examples, the aggregation platform 101 is configured to aggregate RGSs from different providers and enable a unified point of integration to licensees. GPAS 102 is configured to communicate with aggregation platform 101 as an RGS e.g. via TPI (Third Party Interface) protocol, as defined by a TPI Specification published by the Gaming Standards Association). GPAS 102 can be further configured to enable the GaaS-mode of operation and is referred to hereinafter as GPAS (Gaming Platform as a Service). GPAS 102 can be configured to enable all necessary game management functions (e.g. executing and resolving game logic, game flows, error flows, regulation requirements, etc.). It can be also configured to provide front-end technologies (e.g. games development kit (GDK)) as well as to generate and deliver game clients to players' browsers. GPAS allows games to be authored once and deployed into multiple channels (e.g. enables omni-channel content delivery to desktop, mobile, casino and/or retail environment).

In some cases, aggregation platform 101 is configured to provide a player with tokens to be used in game operation. Tokens can be considered as a shared currency between the games. In some examples, tokens can be generated by the games. In some examples, tokens can be generated in one game, and be spent by the player, in another game. In some examples, the currency, e.g. the tokens, can also be generated outside of the games, e.g. by a licensee of the game. In some examples, tokens can be acquired by players with real money.

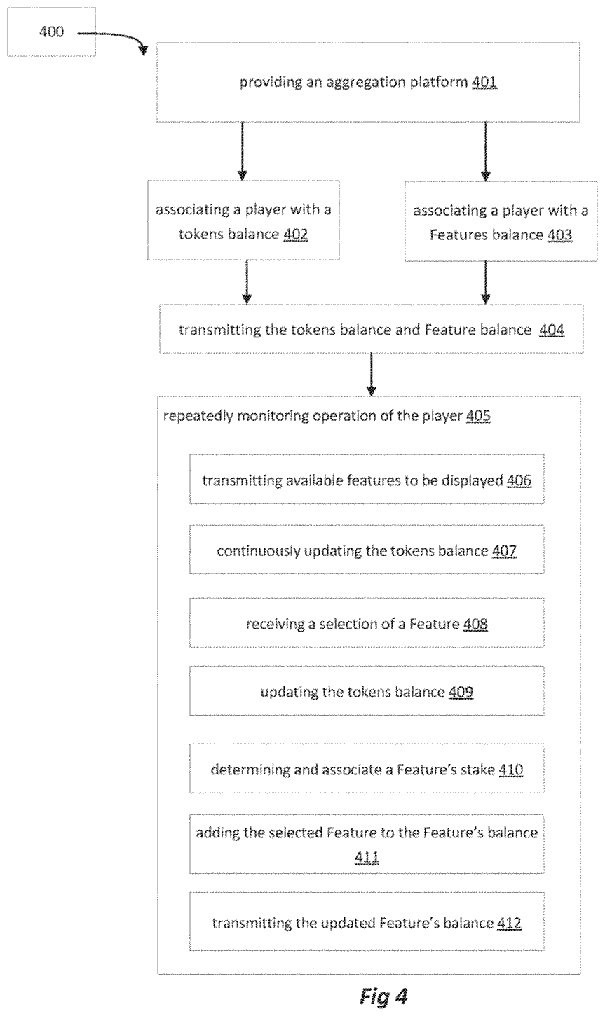

In some cases, tokens can be used by the player to acquire shared Features. Aggregation platform 101 is configured to provide the player with one or more Features to be operated in one or more of the plurality of games. The term “Feature” should be expansively construed to cover any kind of game, in-game options and/or out-game options defined as acquirable by tokens. The term “Feature” includes games and/or options that can be triggered with and/or without spending tokens. For example, the Features can be in-game options and/or out-game options, such as pick bonus or free game. Each Feature has a respective predefined cost value in terms of a number of tokens. For example, the predefined cost value of a Feature can be the Feature cost, i.e. the number of tokens required to acquire the Feature (fCost). In addition, each Feature is further characterised by a Feature's stake (fStake) value. in some examples, a Feature's stake value represents the total bet of the player in the games. A Feature's stake value is determined at the time of a feature acquisition, based on history of actions of the player over time, as reflected by tokens, as further explained below with respect to a Token balance trail. The Feature's stake is used during a Feature operation, in accordance with Feature logic. For example, if the Feature is free games, then Feature Stake is total bet per free games' spin. If Feature is a pick bonus, then Feature Stake is a value to be multiplied by the bonus item multiplier. Determining a Feature's stake value is further described below with respect to FIG. 4. Traditionally, in known systems, a Feature is provided to a player, and can be operated in a single game played by the player. In such known systems, the Feature's stake is calculated based on the players activity in the single game and the pending token balance is dependent on the single game only. In some cases, according to the presently disclosed subject matter, aggregation platform 101 is configured to provide a player with Features to be operated in one or more of the plurality of games, based on activity of the player in the plurality of games, and based on token balance dependent on the plurality of games. Aggregation platform 101 is configured to aggregate data pertaining to players' activity in the plurality of games, and to determine the Feature's stake, based on activity in the plurality of games. Aggregating the data from the plurality of games and determining the Feature's stake based on the aggregated data enables aggregation platform 101 to provide to a player Features to be operated in the plurality of games. In some non-limiting examples, aggregation platform 101 is configured to aggregate data that pertains to the activity of a player in a plurality of games, and provide the player with a Feature to be operated in a new game, for which data on the user's activity was not received and aggregated by the aggregation platform 101.

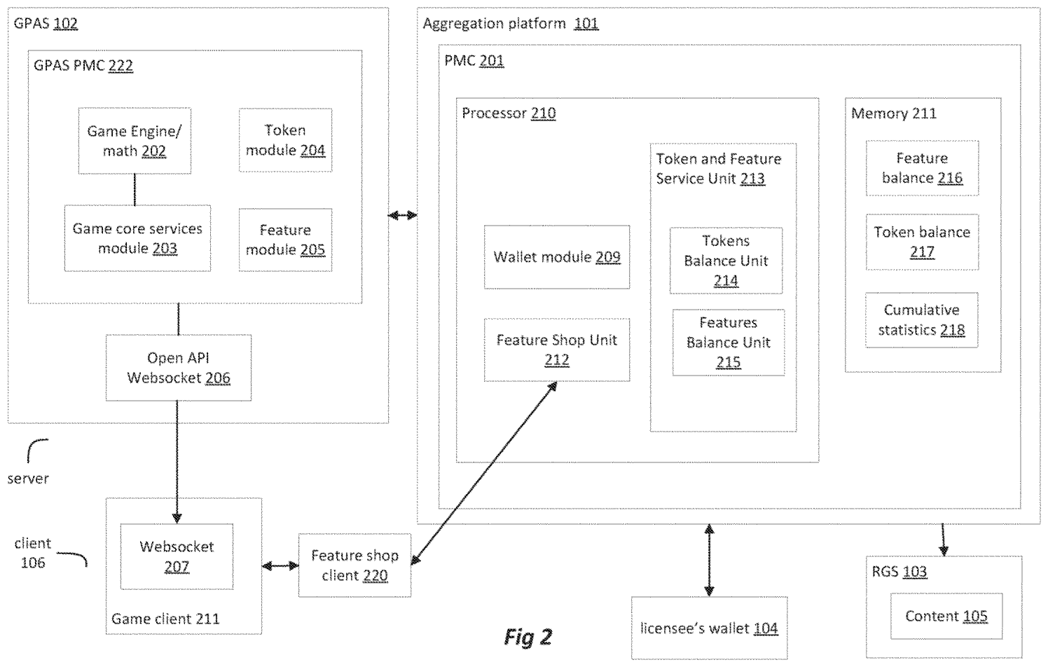

Referring to FIG. 2, there is illustrated a high-level functional block diagram of several entities in the gaming environment, in accordance with certain embodiments of the currently presented subject matter. Aggregation platform 101 is configured to enable operation of one or more Features in a plurality of games, based on a player's activity in the plurality of games. In some cases, aggregation platform 101 comprises a processor and memory circuitry (PMC) 201 comprising a processor 210 and a memory 211. The processor in PMC 201 is configured to execute several functional modules in accordance with computer-readable instructions implemented on a non-transitory computer-readable storage medium. Such functional modules are referred to hereinafter as comprised in the processor. The processor 210 can comprise wallet module 209, Feature Shop unit 212 and Token and Feature service Unit 213. Token and Feature service Unit 213 can comprise Tokens Balance unit 214 and Features Balance unit 215. Memory 211 can store, for each player, Feature balance 216, tokens balance 213 and cumulative statistics 218. The Feature balance 216, tokens balance 213 and cumulative statistics 218 are dynamically updated, based on game events of the player as received from GPAS 102 and RGS 103, as explained further below.

In some cases, aggregation platform 101 can operatively be connected to GPAS 102. GPAS 102 is operatively coupled to one or more clients 106 configured to run one or more games clients 211. GPAS 102 can further be operatively coupled, directly or via platform 101, to licensee's wallet 104. GPAS 102 comprises a processor and memory circuitry (PMC) 210 comprising a processor and a memory (not shown separately). The processor in GPAS PMC 222 is configured to execute several functional modules in accordance with computer-readable instructions implemented on a non-transitory computer-readable storage medium. Such functional modules are referred to hereinafter as comprised in the processor of GPAS PMC 222. The processor of PMC GPAS 210 can comprise game engine/math 202, game core services module 203, token module 204 and Feature module 205. GPAS 102 is implemented on a server and comprises a hardware-based interface configured as an open API websocket, denoted by open API websocket 206, enabling communication with websocket 207 of a client 106. GPAS can be configured to operate both as a client and as a server. The client side, e.g. a game UI, is denoted by client 106. The server side, e.g. game engine/math 202 in GPAS 102 is denoted by GPAS 102 being a server. When a GPAS game client 211 runs in a browser at a client 106 side, it creates a connection to GPAS 102 server, e.g. to game engine/math 202 included in GPAS 102. Game engine/math 206 is operatively connected to game core services module 203. Game core services module 203 can comprise several service functional modules configured to provide core services necessary for hosting game engines (e.g. random number generation, game history service, state persistence service, message routing service, regulatory compliance services, etc.). A combination of a game client 211 with a Game Engine/match 202 configured to run on GPAS, constitutes a GPAS game and enables the GaaS mode of operation of GPAS 102.

In some cases, aggregation platform 101 is configured to enable operation of one or more Features in a plurality of games, based on player's activity in the plurality of games. In order to monitor a player's activity in the games, Token and Feature Service Unit 213, e.g. using Tokens Balance Unit 214, is configured to associate a player with a tokens balance, for example, when the player places a new bet. Token and Feature Service Unit 213 is configured to transmit the associated tokens balance to the GPAS 102, e.g. to token module 204. Token module 204 is configured to provide token services to client 106, including e.g. displaying the tokens balance to the client and generating new tokens based on token math as stipulated e.g. by game engine/math 202. The tokens are usable by the player in plurality of games hosted by the RGSs 103 and the GPAS 102, for example to acquire Features to be operated in the plurality of games. Feature module 205 is configured to receive Features balance from aggregation platform 101 and display the Features balance to the player. The Feature's balance includes at least one Feature available to be acquired by the player.

In some case, Tokens Balance Unit 214 is configured to update the token balance, based on data on game events received at aggregation platform 101. Hence, in response to receipt from one or more RGSs or the GPAS, data on game events generated in games, Tokens Balance Unit 214 is further configured to dynamically update the tokens balance, according to a predefined gaming configuration. Game events can include for example, a new player started to play, a new bet was placed by an existing player, a new game has been started by the player, in-game event such as winning a certain payout size, triggering a specific in-game bonus free game or receiving no wins for a number of game rounds, a licensee operating a game activated a promotional event, scheduled event and predefined money deposit. In some examples, game events can include a player acquiring tokens with real money. The predefined configuration can include configuration relating to allocating new tokens or decreasing a number of tokens when any of the above events occur.

In some examples, the tokens balance is updated in response to receipt of game events from the plurality of RGSs or the GPAS, and hence, it is aggregated across multiple games and RGSs. The updated tokens balance over a selected time interval or portion thereof constitutes a token balance trail. As explained further below, the token balance trail may be used to determine on the Feature's stake.

In some examples, the updated tokens balance is sent to the GPAS 102, e.g. to token module 204 to provide the updated tokens balance to the user, for example by displaying it to the player through player's devices. Optionally, token module 204 generates new tokens.

In some cases, aggregation platform 101 is further configured to associate a player with one or more Features. Some examples of Features include a game, in-game options, and out-game options. Features can be acquired by the tokens, wherein each Feature can have respective predefined cost value in terms of a number of tokens, and wherein each of the Features is operable in a game. The operation of the Feature in a game is dependent on a Feature's stake value associated with the respective Feature. A Feature's stake value is determined at the time of a feature acquisition, e.g. as calculated by the wallet module 209, based on the history of actions of the player. The Feature's stake is usable during a Feature operation at client 106, in accordance with Feature logic. Determining a Feature's stake value is further described below.

In some cases, a Feature shop client 220, a client component, operatively communicates with both aggregation platform 101, e.g. through Feature Shop unit 212, and with game client 211. Feature shop client 220 is configured to receive from

Feature Shop unit 212 data pertains to one or more available Features to a player, and data pertains to Tokens balance. In some examples, game client 211 can direct a player to Feature shop client 220, e.g. by pressing a designated link on the game. Feature shop client 220 is configured to display to the player the available Features which can be acquired by him, and his current Tokens balance. The player can acquire a desired Feature, by selecting a Feature from the available displayed Features.

In some cases, the updated tokens balance over a selected time interval or portion thereof constitutes a token balance trail. The trail can be referred to as the history of player's activity, as reflected by the tokens, in a time interval. This activity may include the number of bets placed by a player in the games, and the amount of size of the bets. The token balance trail can include data indicative of the updates made to the token balance in response to receipt of game events, over a time interval or a portion thereof. The length of the time interval can be dynamically determined by the aggregation platform 101, for example, the aggregation platform 101 may determine that the time interval determining the trail is 1 past day, 1 past week etc. Alternatively or additionally, aggregation platform 101 may determine that at a given time period, the time interval may be shorter or longer than the general determined time interval.

Upon selection of the Feature by the player, wallet module 209 comprised in Aggregation platform 101 is configured to calculate player's statistics, based on the tokens balance trail of the player. The statistics may relate to the total number of bets and the size of the bets, include e.g. frequency of betting over time interval, average bet amount, etc. The calculated player's statistics can then be used to determine a Feature's stake value of the Feature selected by the player. Once a feature's stake is determined, Token and Feature service Unit 213, e.g. by Feature balance unit 215, is configured to update the Feature's balance 212 stored in Memory 211 with the selected Feature with the determined Feature's stake, thereby enabling operation of the selected Feature in one or more games. The calculation of the Feature's stake is further described below with respect to FIG. 4. The updated Feature's balance 216 may be transmitted by Feature Shop unit 212 to the player, e.g. by Feature shop client 220, and the player can activate the acquired Feature.

It is noted that the teachings of the presently disclosed subject matter are not bound by the entities described with reference to FIGS. 1 and 2. Equivalent and/or modified functionality can be consolidated or divided in another manner and can be implemented in any appropriate combination of software with firmware and/or hardware and executed on a suitable device. In certain embodiments, aggregation platform 101 and/or GPAS 102 can be implemented in multi-tenancy clustered architecture so that multiple instances of each server component run across multiple server nodes, providing both resilience and scalability. Wallet Module 209 can comprise a plurality of separate wallets (per each licensee) implemented on the same or on different servers; optionally, part of the functions of the separate wallets can be integrated in a centralized manner. In certain embodiments, at least some of the described functional modules such as Feature Shop Unit 212, Token and Feature service Unit 213, Feature shop client 220 and other entities can be implemented as a standalone entity (or as entities), apart of other entities (such as comprised totally or partially in other entities illustrated in FIG. 2, and may operatively connected to one or more of the GPAS 102, the aggregation platform 101 or game client 211.

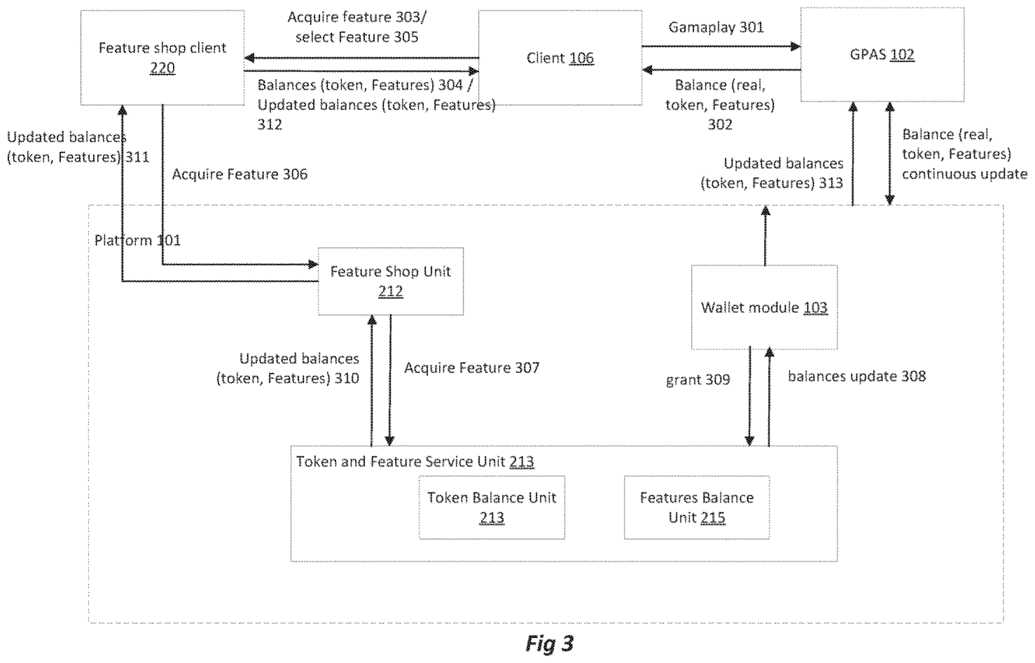

Reference is now being made to FIG. 3, illustrating a generalized diagram of feature acquisition flow in accordance with certain embodiments of the presently disclosed subject matter.

A game framework comprises a gameplay flow (301) when client 106 interchanges game data with GPAS 102, e.g. when client 106 starts or ends a game hosted by GPAS or places a new bet. GPAS 102 is configured to transmit (302) to client 106 data on the player's balances, e.g. Tokens balance, Features balance and “real money” balance. Token balance may include all tokens of the player, Feature balance may include one or more Features previously acquired by the player and “real money” balance may include current money balance of the player. The data on Tokens balance, Features balance and “real money” balance may be transmitted from aggregation platform 101 to GPAS 102 in accordance with the continuously update of data between aggregation platform 101 and GPAS 102.

In some examples, Client 106 issues (303) a request to acquire a Feature, e.g. by pressing a designated link on the game. Feature Shop client 220 displays (304) to client 106 a list of Features, including one or more Features available for acquisition by client 106, and the current Token balance of the player. In some examples, Feature shop client 220 received the data on the current Token balance from Feature Shop Unit 212. Upon a display of the available Features and Tokens to the player, the player may select one or more Features to acquire. In such cases, Feature shop client 220 receives (305) a selection of a Feature from client 106. Responsive to the selection, Feature Shop client 220 sends (306) to Feature Shop unit 212 an “Acquire Feature” request specifying the selected Feature and the number of tokens to be reduced. The number of tokens may be the predefined cost value of the selected Feature. Feature shop unit 212 transmits (307) the received “Acquire Feature” request to Token and Feature service Unit 213. Upon receiving the request, Token and Feature service Unit 213 sends (308) to Wallet Module 103 respective data on token and Feature balances update, and receives (309) a grant, when appropriate. In response to receipt of a grant, data on updated Feature and Token balances is sent (310) to Feature Shop unit 212. The updated Feature balance may include data indicative of the addition of the granted Feature to the Feature balance. The updated tokens balance may include the number of tokens in the balance, after degrading the number of tokens according to the Feature's cost value of the selected Feature. Token and Feature service Unit 213 transmits (311) to Feature Shop client 220 the updated balances which are then transmitted (312) to client 106, optionally, for consumption of the selected Feature.

Upon sending the grant to Token Service Unit 213 (grant 309), Wallet Module 103 updates the Feature and Token balances and sends (313) the updated balances to GPAS 102. GPAS 102 may transmit (302) the received updated balance to client 106.

Referring now to FIG. 4, there is illustrated a general flowchart of operations performed in aggregation platform 101, in accordance with certain embodiments of the presently disclosed subject matter. The stages below are illustrated with respect to entities in the gaming environment illustrated with respect to FIGS. 2 and 3. However, this should not be considered as limiting and those skilled in the art will readily appreciate that the stages below can, likewise, be executed by other/different entities in a gaming environment.

In some cases, an aggregation platform 101 is provided. The aggregation platform 101 operatively communicating with at least one remote game server (RGS) 103. The aggregation platform 101 further operatively communicating with a Gaming Platform as a Service (GPAS) 102. Both the RGS 103 and the GPAS 102 hosting a plurality of games to be provided to a plurality of players (block 401). In some examples, the GPAS 102 operating as an RGS and providing GaaS mode of operation.

In some cases, the aggregation platform 101 comprising a feature shop unit 212. Feature shop unit 212 operatively communicating with a feature shop client 220, which in turn, operatively communicating with the players' devices, such as game client 211. In addition, the aggregation platform 101 comprising a token and feature service unit 213.

In some examples, the GPAS 102 exchanges with aggregation platform 101 data that pertains to the activity of the player in a game. Hence, the GPAS 102 may receive from the aggregation platform 101, e.g. by token and feature service unit 213, data pertaining to tokens balance and/or Features balance, both associated with a player, and provides the received data to the player.

In some cases, the tokens can be used by the player in a plurality of games, for example to acquire one or more Features from a list of available Features. Each of the Features has a respective predefined cost value in terms of a number of tokens. For example, the predefined cost value of a Feature can be the Feature cost in a number of tokens required to acquire the Feature (fCost). In some examples, the predefined Feature cost may vary, e.g. upon determining of a limited time discount for all Features. In cases where more than one type of token was generated, the predefined cost value of a Feature may vary, depending on the type of tokens, and/or a combination thereof.

In addition, each Feature is further characterised by a Feature's stake (fStake) value. In some examples, a Feature's stake value represents the total bets of the player in the games. A Feature's stake value is determined at the time of a feature acquisition, based on the history of actions of the player over time, e.g. based on the Token balance trail.

In some cases, for each player of the plurality of players, the processor 210 of the aggregation platform 101 may executes the stages referred to in blocks 402-412. Token and feature service unit 213 associates a player with a tokens balance comprising one or more tokens (block 402).

In addition, in some cases, Token and feature service unit 213 further associates the player with a Features balance comprising one or more Features (block 403). The Feature balance includes the Features acquired by the player which are pending to be operated in one or more games. Each Feature is associated with a respective Feature's stake value, e.g. as determined when the Feature was acquired.

In some examples, the tokens balance and Features balance can be stored e.g. in Token balance 217 and Feature balance 216 in memory 211.

The associated tokens balance and Features balance are then transmitted to the player, e.g. through GPAS 102 (block 404).

Upon receipt of the associated token balance and the Feature balance by GPAS 102, and before transmitting the balance to the player, token module 204 in GPAS 102. can generate tokens to the player, based on the received associated tokens balance, e.g. responsive to gaming configuration. As mentioned above, game configuration can include predefined game events such as new player, new bet, new game, in-game event, promotional event, scheduled event, certain money deposit. The tokens can be generated automatically and/or in response to a player's purchasing thereof. In some examples, aggregation platform 101 can associate at least two types of tokens to a player. In such examples, at least two respective token balance are associated with the player and are transmitted to GPAS 102. Upon receipt of the associated by the GPAS 102, processor in PMC 222 generates at least two types of tokens and the player is associated with at least two separate tokens balances per each token type, respectively. In these examples, in response to receipt from the at least one RGS or the GPAS of the data on game events, token and Feature Service Unit 2013 continuously updates the balance of a first token type, and does not update the balance of the second token type.

For purpose of illustration only, the following description of tokens and updating tokens balance is provided for gaming systems configured to enable spin-based games. Those skilled in the art will readily appreciate that the teachings of the presently disclosed subject matter are, likewise, applicable to gaming systems configured to enable other games using RTP-based math (e.g. baccarat, lottery, poker, bingo, scratch card game, wheel of lucks, etc.)

By way of non-limiting example, each given player can be associated with three different types of tokens that are maintained, e.g. by wallet module 209: game tokens (GTs), pending game tokens (PGTs) and promotional tokens (PTs). Accordingly, processor 210 can associate each given player with three separate balances per each token type. Optionally, processor 210 associates and transmits data on all three balances to GPAS 102, while GPAS 102 determines to display only the balances of GTs and PTs to the player, and determines to display the balance of PGTs to a licensee of the game only.

In some examples, the processor 210 associates with a player a random number, based on an outcome of a random number generator (less than a predefined max number) of GTs on every bet the player places in the game. Optionally, processor 210 associates with a player a random number of GTs responsive to other predefined game events. Optionally, each number of provided GTs can have an associated weight. By way of non-limiting example, depending on the number of provided GTs, the weight can decrease with increase of the number of provided game tokens. By way of alternative non-limiting example, depending on the number of provided GTs, the weight can increase by increasing the number of provided game tokens.

Once the token balances were associated with the player, the are transmitted to the player through GPAS 102, e.g. by displaying them to game client 211. Following are non-limiting examples of a display. Processor in PMC 222 can randomly distribute the signs of provided GTs over the reels. Distribution of token signs on reels is defined by the math of the respective game. For example, the math can allow showing token signs only on certain reels, or restrict token signs on some symbols. Distribution and visualization of the provided GTs can be implemented in different ways. By way of non-limiting example, GT signs can appear as though they are coming from the reels together with symbols. Optionally, it can be possible to show several GT signs above the same symbol. By way of other non-limiting examples:

in a slot machine, special symbols or combinations of symbols can increase the number of GTs;

in roulette, a designated sector can increase the number of GTs;

in blackjack, a card value and/or suit can determine the number of collected GTs; etc.

Referring back to FIG. 4, in some cases, processor 210 repeatedly monitors operation of the player (block 405). Monitoring the operation enables the aggregation platform 101 to provide usage of Features in a plurality of games, based on activity of the players in the games, as reflected by the Tokens. Monitoring the operation of the Features can be done by the operations denoted in blocks 406-411.

Feature shop unit 212 can transmit the available Features to be displayed at the player's device (block 406). In some examples, the list can include one or more Features to be acquired by the player. The player can choose to operate one or more of the available features in one or more games.

In response to receipt from at least one RGS or the GPAS data on game events generated in one or more of the plurality of games token and feature service unit 213 continuously updates the tokens balance according to a predefined configuration (block 407). Unless specifically stated otherwise, it is appreciated that throughout the specification the terms “continuously updating” or the like refer to receiving (in push or pull mode) data substantially each time new data is available to aggregation platform 101 and/or responsive to predefined events (including scheduled events and events occurring in accordance with predefined periodicity). In some examples, updating the token balance includes upgrading or degrading the number of tokens in the tokens balance. In some examples, updating the tokens balance includes selectively updating the tokens balance, for example, when data on game events is received, but the tokens balance is not updated based on the received data on game events.

To continue with the examples in which more than one token type is generated, in some examples, token and feature service unit 213 token and feature service unit 213 continuously update the PGT tokens balance by associating the player with PGT, e.g. every time it associates the player with a GT. In some examples, the number of PGTs provided on a given spin is a function of GTs provided on the same spin. Optionally, a licensee operating a game hosted on the at least one RGSs of the GPAS, can release one or more tokens of one or more token types, e.g. PGT (within the current PGT balance), to the player. The licensee can release, responsive to predefined events (e.g. a new player, an existing player when starting a new game, depositing a specific amount of money, triggering an in-game Feature, etc.). In response, token and feature service unit 213 updates the tokens balances by decreasing PGT tokens balance and increasing GT tokens balance by the number of released PGTs. Optionally, if the number of PGTs that a licensee wants to release exceeds PGTs balance, token and feature service unit 213 can suggest completing the remaining amount with PTs, responsive to which the PT tokens balance is decreased.

It is noted that neither GTs nor PGTs are provided in connection with a Feature's operation. It is further noted that GTs and PGTs affect the RTP (return to player) of the underlying game. Accordingly, the game math is generated in accordance with the predefined weights of random numbers of generated GTs and the number of PGTs depending on the number of generated GTs. Accordingly, the respective tokens' balances are continuously updated.

Yet another example of updating the tokens' balances of certain type of tokens, in some examples, the token and feature service unit 213 further enables a licensee to credit to a player one or more Promotional Tokens (PT) characterized by a predefined monetary value and lifetime. Upon receipt of an indication of a licensee that release PT to a player, the PT tokens' balance is updated accordingly. It should be noted that unlike GTs or PGTs, PTs have underlying monetary value credited by a licensee, together with PTs. The money thus credited to a player is a function of a number of credited PTs and an estimated average Games' stake of a player. Thus, the PT can be also outside of game RTP.

As detailed above, token and feature service unit 213 e.g. using wallet module 209 separately maintains GT, PGT and PT balances. In some examples, the overall balance status of a player can be in a regular mode, or in a capped mode. A player starts in a regular mode. In this mode, all types of tokens are available. A player's overall balance moves to a capped mode when the total amount of GTs and PTs reaches a predefined cap. It is noted that a player does not necessarily move to a capped phase when the number of PGTs reaches a cap, but only if, after transferring PGTs to the GT balance, the number of GTs and PTs reaches a cap. In capped mode, the player is not able to collect or receive any types of tokens until the total number of GTs and PTs becomes less than the cap and the player returns to the regular mode. The number of tokens is reduced when the player spends tokens to buy a Feature, and/or when some tokens expire. Optionally, the different tokens can be configured to have different consuming priority. By way of non-limiting example, GTs can have higher priority than PTs; within the same type, tokens with sooner expiry time can have a higher consuming priority.

As explained above, in the examples, more than one token type is generated and associated with the player. For example, the following tokens can be generated: GTs, PGTs, PTs tokens. In such cases, the player is associated with separate tokens balances for per each token type. In some examples, in response to receipt from the at least one RGS or the GPAS data on game events of a player, token and feature service unit 213 is configured to continuously update the balance of the first token type and does not update the balance of the second token type.

As explained, in response to receipt of data on game events, the tokens balance is continuously updated. In some cases, the updated tokens balance, over a selected time interval or portion thereof, constitutes the token balance trail.

In some cases, feature shop unit 212 receives from the player's device, e.g. through feature shop client 220 a selection by the player, of one or more Features from the list of available Features (block 408). The selected Feature can be operated in at least one game of the plurality of games hosted by the RGS and the GPAS. In some examples, the selected feature is operable in more than one game. Yet, in some examples, the selected Feature is operable in a new, given, game, for which data on game events was not received by the aggregation platform 101, and accordingly, aggregation platform 101 did not update the tokens balance based on game events that were generated in the given game.

In some cases, based on the selection, token and feature service unit 213 updates the tokens balance (block 409). In some examples, updating the Feature's balance includes degrading the number of tokens according to the feature cost value of the selected Feature.

Based on the selection, tokens and feature service unit 213 determines a Feature's stake value of the selected Feature, based on the tokens balance trail and associates the determined Feature's stake with the selected Feature (block 410). As described above, each Feature is characterized by a Feature cost in tokens (fCost) and by a Feature stake (fStake). A Feature's stake value is determined at the time of a feature acquisition, based on the token balance trail as updated until the acquisition time.

In some examples, in order to determine a Feature's stake, tokens and feature service unit 213 calculates cumulative statistics of the player, at the time of acquisition of the Feature by the player. Cumulative statistics are indicative of the activity of a player in the games, and may be based on the bets placed by the player. Following is a non-limiting example of cumulative statistics used by wallet module 209. Cumulative statistics of each given player include:

N—cumulative statistic that depends on a number of bets placed by a player, and

S—cumulative statistic that depends on a monetary sum of bets that are placed by a player.

The cumulative statistics can be stored e.g. in cumulative statistics 218 in memory 211.

The cumulative statistics are updated responsive to usage tokens, as updated in Tokens balance 217. Optionally, if more than one type of tokens is generated, e.g. game tokens (GTs), pending game tokens (PGTs) and promotional tokens (PTs), and separate balances are associated for each of the tokens types, the cumulative statistics can be updated responsive to decrease of the GT balance only. Yet, optionally, whenever game tokens (GT) balance decreases, either after expiry or buying a Feature, cumulative statistics are updated. The tokens balance trail over a selected time interval or portion thereof can be used to extract the above data for calculating the cumulative statistics.

By way of non-limiting example, once the cumulative statistics are calculated, tokens and feature service unit 213 calculates Estimated Average Stake of a player. The Estimated Average Stake can be calculated based on the cumulative statistics, the number of GT used to buy the Feature, the number and monetary value of PT used to acquire the Feature, and fCost of the Feature. In some examples, tokens and feature service unit 213 determines a Feature's stake as a function of the calculated Estimated Average Stake of the Player. For example, the Feature's stake can be identical to the Estimated Average Stake. Alternatively, the Feature's stake can be a manipulation of the Estimated Average Stake. Thus, the Feature's stake, while having the same cost in the number of tokens, is variable, depending on a player's cumulative statistics. Thus, two Features can have an identical fCost but different fStake.

In some cases, once the Feature's stake is determined and is associated with the selected Feature, token and feature service unit 213 adds the selected feature to the Feature's balance, thereby enabling operation of the selected Feature, according to the feature's stake (block 411).

The update feature's balance is then transmitted, by the feature shop unit 212 to the player's device (block 412), for example through Feature shop client 220.

In some examples, the selected Feature that was acquired by the player is operated in a given game, for which data on game events in that given game were not received by aggregation platform 101, and, accordingly, tokens balance was not updated based on such game events.

In some examples, Feature Shop Unit 212 further transmits the updated tokens balance to the player, e.g. by feature shop client 220 or by GPAS 102. It should be noted that aggregation platform 101 uses the same token balance for the plurality of games across the RGSs and GPAS, and calculates cumulative statistics based on the updated tokens balance trail. The calculated cumulative statistics are then used to determine a Feature's stake to be operated in a game. Using the same token balance for the plurality of games, and calculating the cumulative statistics not only enables a player to use his activity in one game to acquire a Feature in another game, but also involves a technological advantage in a reduced computational resources and time by tracking a single balance for each token type for all games, without the need to track balances for each game, and continuously updates the balances in response to game events, which are known to be frequent, in a large amount and in real time, in a gaming environment. Also, the cumulative statistics already consider the possibility of variable bets by the player in the same game, or across games, thus monitoring is manageable in a single balance, without losing data on the player's activity.

The above gaming system and method was described with respect to a non-limiting example of a token balance that is updated based on a player's activity in various games, and with respect to Features, which can be acquired based on the player's activity as reflected by the tokens balance. However, the above non-limiting example of Features should not be considered as limiting, and other player or game parameters can be monitored and be updated based on the tokens balance. As such, following is a description of States that can be applied in one or more games. In some examples, States can be operated and be applied in a similar manner to Features and those skilled in the art will readily appreciate that the teachings of the presently disclosed subject matter is, likewise, applicable to States rather than to Features only. In some examples, States can include a state of user in a game or a state relating to achievements of the user such as reaching a certain game stage or obtaining certain measurable points. For example, states may include ‘a pick bonus’, ‘number of in-game free spins’, ‘a multiplier of winnings’ ‘certain pre-determined symbols in the game result’ or a ‘visual effect’.

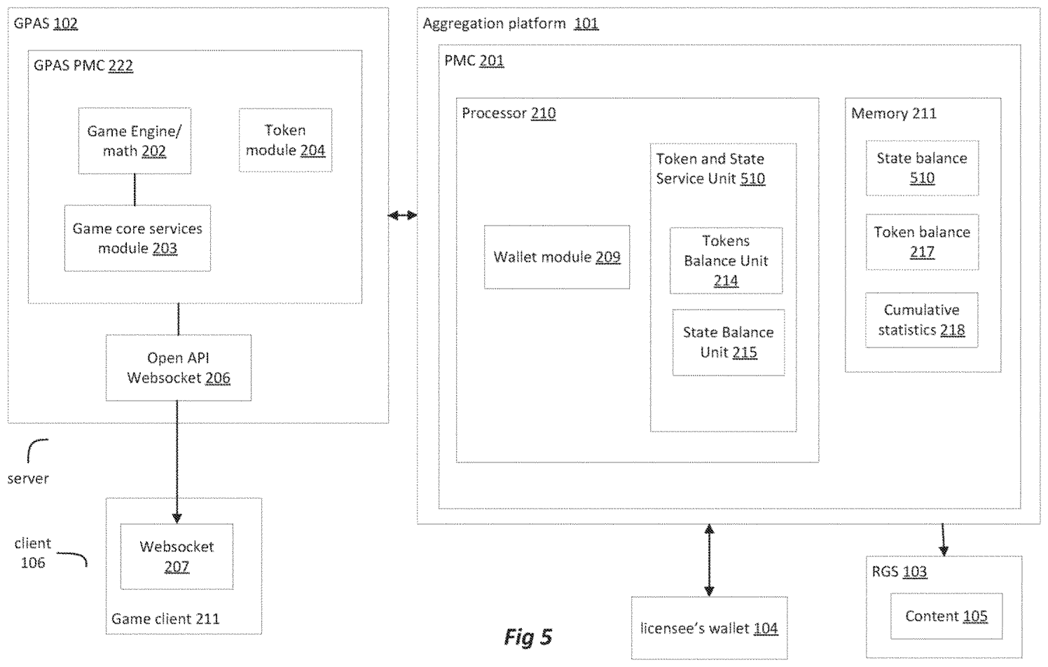

Having that in mind, reference is now being made to FIG. 5, illustrating a high-level functional block diagram of several entities in the gaming environment configured to operate shared States, in accordance with certain embodiments of the presently disclosed subject matter.

In some cases, several entities appearing FIG. 2 appear also in FIG. 5 and are configured to operate in a similar manner with respect to both Features, as described above, and with respect to shared States, as illustrated below. Also, new entities, included in the block diagram of FIG. 5, may correspond in functionality of entities appearing in FIG. 2, and hence, the disclosure above with respect to these entities is also applicable with respect to the entities appearing in FIG. 5.

As such, aggregation platform 101 may be provided. The aggregation platform 101 includes PMC 201, and processor 210 and memory 211, as illustrated in FIG. 2. Processor 201 includes several entities similar to FIG. 2, and further includes Token and State Service Unit 510 which may function in a similar manner to Token and State Service Unit 213 of FIG. 2. Token and State Service Unit 510 comprising Tokens Balance Unit 214 and State Balance Unit 215 configured to monitor the player's state. In a similar manner to FIG. 2, memory 211 may store State balance 510, in addition to tokens balance 217 and Cumulative statistics 218.

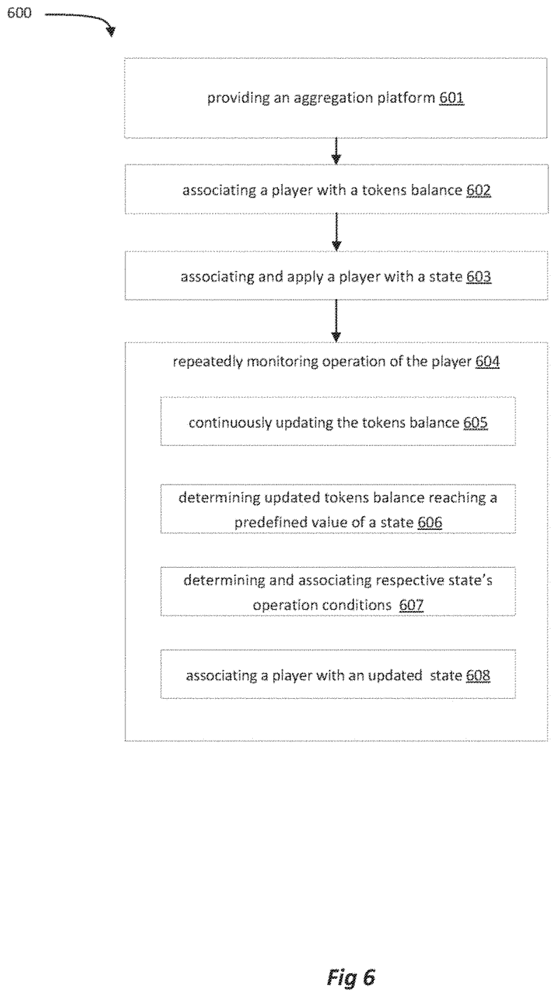

Reference in now being made to FIG. 6, illustrating a general flowchart of operations performed by platform 101 appearing in FIG. 5, in order to operate shared States, in accordance with certain embodiments of the presently disclosed subject matter. Reference is being made to the disclosure made with respect to operations in FIG. 4, as applicable also to operations performed in FIG. 6.

In some cases, an aggregation platform 101 is provided (block 610). Similar to the disclosure of operations relating to block 401, the aggregation platform 101 operatively communicating with at least one remote game server (RGS) 103, the aggregation platform further operatively communicating with a Gaming Platform as a Service (GPAS) 102. The at least one RGS 103 and the GPAS 102 hosting a plurality of games to be provided to a plurality of players. In some examples, the GPAS 102 further receives from the aggregation platform 101 data pertaining to tokens balance and/or one or more states, both associated with a player, and provides the data to the player.

In some examples, each state has a respective predefined value in terms of a number of tokens, in a similar manner to that described above with respect to predefined cost value of a Feature. In some examples, each state may be applied in one or more games of the plurality of games, based on a respective state's operational conditions. A respective state's operational conditions may be defined in a similar manner to that described above with respect to Feature's stake and is further described below.

In some cases, the processor of aggregation platform 101, e.g. by Token and State Service Unit 510, associates a player with a tokens balance comprising one or more tokens (block 602), in a similar manner to that described above with respect to block 402.

In addition, in some cases, the processor of aggregation platform 101, e.g. Token and State Service Unit 510, further associates the player with a state balance comprising one or more states. In some examples, associating the states is based on the respective predefined value of each state. For example, Token and State Service Unit 510 may determine that based on the token balance, a predetermined value of one or more states has been reached. In response, Token and State Service Unit 510 may determine associate the state with the player, and in some examples, applying the one or more states in one or more games based on their respective state's operation conditions (block 603). Since applying a state does not require acquisition or selection by a user, a state may be applied by aggregation platform, when, based on the tokens balance, the predetermined value of the state has been reached. The state may be applied based on its respective state's operation conditions. The state's operation conditions are further described below.

Processor 210 repeatedly monitors operation of the player (block 604), in a similar manner to that described above with respect to block 405. Monitoring the operation enables the aggregation platform 101 to apply a shared in a plurality of games, based on activity of the players in the games, as reflected by the Tokens balance. Monitoring the operation of the Features can be done by the operations denoted in blocks 605-607.

In some examples, in response to receipt from the at least one RGS or the GPAS data on game events generated in the plurality of games, processor 210 continuously updates the tokens balance according to a predefined configuration, wherein the updated tokens balance over a selected time interval or portion thereof constitutes a token balance trail (block 605). Receiving data on game events, and updating tokens balance can be done in a similar manner to the described above with respect to block 407.

In some cases, processor 210 determines that the updated tokens balance reaches a predefined value of one or more of the states (block 606). For example, processor 210 may constantly compare the tokens balance to the predefined value of the states, and flag when the tokens balance reaches one of the predefined values. The one or more states for which the predefined values have been reached may constitute states-to-update.

In some examples, processor 210 then determines respective state's operation conditions for each one of the states-to-update, based on the tokens balance trail, and associates each of the one or more states-to-update with the respective determined state's operation conditions (block 607). In some examples, the state operational conditions are determined based on the tokens balance trail with respect to the category of the state. For example, for player status state, the state's operation conditions may be based on the status of the player in a game, as reflected by the on the tokens balance trail. For example, if the game provides a prize when the player obtains a certain number of levels, and obtaining each level is dependent on the tokens balance trail, then the state's operation conditions can be determined to be the current level obtained by the player. However, this should not be considered as limiting and those skilled in the art will readily appreciate that other states operational conditions, which may be based also on cumulative statistics, in a similar manner to that described above with respect to block 410.

Once the state's operation conditions of the states-to-update are determined, processor 210, e.g. using State Balance Unit 215, may associate the player with the states-to-update (block 608), e.g. by adding them to state balance 510 stored in memory 211. In some examples, processor 210 apply the one or more states-to-update in one or more games, based on the associated state's operational conditions.

Optionally, the tokens balance is updated, based on the one or more states-to-update, e.g. by degrading the state predefined value of each one or more states-to-update.

It is noted that the teachings of the presently disclosed subject matter are not bound by the game flow and flow chart illustrated in FIGS. 3, 4 and 6, and that the illustrated operations can occur out of the illustrated order. For example, operations 402, and 403 or 602 and 603 shown to be executed in a particular sequence, can occur in succession, can be executed substantially concurrently, or in the reverse order. It is also noted that whilst the flow chart is described with reference to elements of system aggregation platform 101, GPAS 102 and Feature shop client 220 this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A gaming system, comprising:
an aggregation platform operatively communicating with at least one remote game server (RGS), the aggregation platform is configured to operatively communicate with a Gaming Platform as a Service (GPAS), the at least one RGS and the GPAS are configured for hosting a plurality of games to be provided to a plurality of players through players' devices,
wherein the GPAS is further configured for receiving from the aggregation platform data pertaining to tokens balance and/or Features balance, both associated with a player, and to provide the data to the player,
wherein the tokens are usable by the player to acquire one or more Features from a list of available Features, wherein each of the Features has a respective predefined cost value in terms of a number of tokens, and wherein each Feature is operable in one or more of the plurality of games, depending on a Feature's stake value associated with the respective Feature,
wherein the aggregation platform comprising:
a feature shop unit, configured to operatively communicate with the players' devices, and
a token and feature service unit;
with respect to each player of the plurality of players operating a player's device, the aggregation platform is configured to:
by the token and feature service unit, associate the player with a tokens balance comprising one or more tokens and with a Features balance comprising one or more Features, the Features have been acquired by the player, wherein each Feature is associated with a respective Feature's stake value;
transmit the associated tokens balance and the Features balance to the player, through the GPAS;
repeatedly monitor operation of the player, including:
transmitting, by the feature shop unit, the list of available Features to be displayed at the player's device;
in response to receipt from the at least one RGS or the GPAS data on game events generated the plurality of games, continuously update, by the token and feature service unit, the tokens balance according to a predefined configuration; wherein the updated tokens balance over a selected time interval or portion thereof constitutes a token balance trail;
receive, by the feature shop unit, a selection of a Feature from the list of available Features, wherein the Feature is operable in at least one game of the plurality of games,
based on the selection, update, by the token and feature service unit, the tokens balance, by degrading the number of Feature's cost value;
determine a Feature's stake value of the selected Feature, based on the tokens balance trail, and associate the selected Feature with the determined Feature's stake;
add the selected Feature, by the token and feature service unit, to the Feature's balance, thereby enabling operation of the selected Feature, according to the feature's stake, and
transmit the updated Feature balance to the player's device, by the feature shop unit.

2. The gaming system of claim 1, wherein token and feature service unit is further configured to transmit the updated token balance to the player, through the GPAS.

3. A method of operating an aggregation platform, comprising:
providing an aggregation platform operatively communicating with at least one remote game server (RGS), the aggregation platform further operatively communicating with a Gaming Platform as a Service (GPAS), the at least one RGS and the GPAS hosting a plurality of games to be provided to a plurality of players through players' devices, wherein the aggregation platform comprising:
a feature shop unit, operatively communicating with the players' devices; and
a token and feature service unit;
wherein the GPAS further receiving from the aggregation platform data pertaining to tokens balance and/or Features balance, both associated with a player, and providing the data to the player,
wherein the tokens are usable by the player to acquire one or more Features from a list of available Features, wherein each of the Features has a respective predefined cost value in terms of a number of tokens, and wherein each Feature is operable in one or more of the plurality of games, depending on a Feature's stake value associated with the respective Feature, the method comprising:
by a processor of the aggregation platform, with respect to each player of the plurality of players:
by the token and feature service unit, associating the player with a tokens balance comprising one or more tokens and with a Features balance comprising one or more Features, the Features have been acquired by the player, wherein each Feature is associated with a respective Feature's stake value;
transmitting the associated tokens balance and the Features balance to the player, through the GPAS;
repeatedly monitoring operation of the player, including:
transmitting by the feature shop unit, the list of available Features to be displayed at the player's device;
in response to receipt from the at least one RGS or the GPAS data on game events generated the plurality of games, continuously updating, by the token and feature service unit, the tokens balance according to a predefined configuration; wherein the updated tokens balance over a selected time interval or portion thereof constitutes a token balance trail;
receiving, by the feature shop unit, from the player's device, a selection of a Feature from the list of available Features, wherein the Feature is operable in at least one game of the plurality of games,
based on the selection, updating, by the token and feature service unit, the tokens balance, by degrading the number of Feature's cost value;
determining a Feature's stake value of the selected Feature, based on the tokens balance trail, and associate the selected Feature with the determined Feature's stake;
adding the selected Feature, by the token and feature service unit, to the Feature's balance, thereby enabling operation of the selected Feature, according to the feature's stake, and
transmits the updated Feature balance, by the feature shop unit, to the player's device.

4. A method of operating an aggregation platform, comprising:
providing an aggregation platform operatively communicating with at least one remote game server (RGS), the aggregation platform further operatively communicating with a Gaming Platform as a Service (GPAS), the at least one RGS and the GPAS hosting a plurality of games to be provided to a plurality of players, the GPAS is further receiving from the aggregation platform data pertaining to tokens balance and/or one or more states, both associated with a player, and provides the data to the player,
wherein each of the states has a respective predefined value in terms of a number of tokens, and wherein each state is applied in one or more games of the plurality of games, based on a respective state's operational conditions, the method comprising:
by a processor of the aggregation platform, with respect to each player of the plurality of players:
associating the player with a tokens balance comprising one or more tokens;
associating the player with one or more states, based on the respective predefined value, and applying the one or more states in one or more games based on their respective state's operation conditions; and
repeatedly monitoring operation of the player, including:
in response to receipt from the at least one RGS or the GPAS data on game events generated in the plurality of games, continuously updating the tokens balance according to a predefined configuration, wherein the updated tokens balance over a selected time interval or portion thereof constitutes a token balance trail;
determining that the updated tokens balance reaching a predefined value of one or more of the states, thereby the one or more states constituting states-to-update;
determining respective state's operation conditions for each one of the states-to-update, based on the tokens balance trail, and associating each of the one or more states-to-update with the respective determined state's operation conditions; and
associating the player with the states-to-update.

5. The method of claim 4, further comprising:
applying the one or more states-to-update in one or more games, based on the associated state's operational conditions.

6. The method of claim 4, further comprising:
updating the tokens balance, based on the one or more states-to-update, by degrading the respective state predefined value of each one or more states-to-update.

7. A gaming system, comprising:
an aggregation platform configured to operatively communicate with at least one remote game server (RGS), the aggregation platform further configured to operatively communicate with a Gaming Platform as a Service (GPAS), the at least one RGS and the GPAS configured to host a plurality of games to be provided to a plurality of players, the GPAS is further configured to receive from the aggregation platform data pertaining to tokens balance and/or one or more states, both associated with a player, and to provide the data to the player,
wherein each of the states has a respective predefined value in terms of a number of tokens, and wherein each state is applied in one or more games of the plurality of games, based on a respective state's operational conditions,
with respect to each player of the plurality of players operating a player's device, the aggregation platform is configured to:
associate the player with a tokens balance comprising one or more tokens;
associate the player with one or more states, based on the respective predefined value, and applying the one or more states in one or more games based on their respective state's operation conditions; and
repeatedly monitor operation of the player, including:
in response to receipt from the at least one RGS or the GPAS data on game events generated in the plurality of games, continuously update the tokens balance according to a predefined configuration, wherein the updated tokens balance over a selected time interval or portion thereof constitutes a token balance trail;
determine that the updated tokens balance reaching a predefined value of one or more of the states, thereby the one or more states constituting states-to-update;
determine respective state's operation conditions for each one of the states-to-update, based on the tokens balance trail, and associating each of the one or more states-to-update with the respective determined state's operation conditions; and
associate the player with the states-to-update.

8. A gaming system for operating one or more game Features, comprising:
an aggregation platform configured to operatively communicate with one or more remote game servers (RGS), configured for hosting a plurality of games to be provided to a plurality of players through players' devices,
wherein at least one RGS of the one or more RGS is a designated RGS configured to receive from the aggregation platform data pertaining to tokens balance and/or Features balance, both associated with a player, and to provide the data to the player,
wherein the tokens are usable by the player to acquire one or more Features from a list of available Features, wherein each of the Features has a respective predefined cost value in terms of a number of tokens, and wherein each Feature is operable in a game of the plurality of games, depending on a Feature's stake value associated with the respective Feature,
with respect to each player of the plurality of players operating a player's device, the aggregation platform is configured to:
associate the player with a tokens balance comprising one or more tokens and with a Features balance comprising one or more Features, the Features have been acquired by the player, wherein each Feature is associated with a respective Feature's stake value;
transmit the associated tokens balance and the Features balance to the player, through the designated RGS;
repeatedly monitor operation of the player, including:
transmit the list of available Features to be displayed at the player's device;
in response to receipt from the one or more remote game servers (RGS) data on game events generated in the plurality of games, continuously update, the tokens balance according to a predefined configuration; wherein the updated tokens balance over a selected time interval or portion thereof constitutes a token balance trail;
receive, from the player's device, a selection of a Feature from the list of available Features, wherein the Feature is operable in at least one game of the plurality of games,
based on the selection, update, the tokens balance, by degrading the number of Feature's cost value;
determine a Feature's stake value of the selected Feature, based on the tokens balance trail, and associate the selected Feature with the determined Feature's stake;
add the selected Feature, to the Feature's balance, thereby enabling operation of the selected Feature, according to the feature's stake.

9. A method of operating one or more game Features, comprising:
providing an aggregation platform operatively communicating with one or more remote game servers (RGS) hosting a plurality of games to be provided to a plurality of players through players' devices,
wherein at least one RGS of the one or more RGS is a designated RGS receiving from the aggregation platform data pertaining to tokens balance and/or Features balance, both associated with a player, and to provide the data to the player,
wherein the tokens are usable by the player to acquire one or more Features from a list of available Features, wherein each of the Features has a respective predefined cost value in terms of a number of tokens, and wherein each Feature is operable in a game of the plurality of games, depending on a Feature's stake value associated with the respective Feature, the method comprising:
by a processor of the aggregation platform, with respect to each player of the plurality of players:
associating the player with a tokens balance comprising one or more tokens and with a Features balance comprising one or more Features, the Features have been acquired by the player, wherein each Feature is associated with a respective Feature's stake value;
transmitting the associated tokens balance and the Features balance to the player, through the designated RGS;
repeatedly monitoring operation of the player, including:
transmitting the list of available Features to be displayed at the player's device;
in response to receipt from the one or more remote game servers (RGS) data on game events generated in the plurality of games, continuously updating, the tokens balance according to a predefined configuration; wherein the updated tokens balance over a selected time interval or portion thereof constitutes a token balance trail;
receiving, from the player's device, a selection of a Feature from the list of available Features, wherein the Feature is operable in at least one game of the plurality of games,
based on the selection, updating, the tokens balance, by degrading the number of Feature's cost value;
determining a Feature's stake value of the selected Feature, based on the tokens balance trail, and associate the selected Feature with the determined Feature's stake;
adding the selected Feature, to the Feature's balance, thereby enabling operation of the selected Feature, according to the feature's stake.

10. A non-transitory computer readable storage medium tangibly embodying a program of instructions that, when executed by a computer, cause the computer to perform a method of operating an aggregation platform, comprising:
providing an aggregation platform operatively communicating with at least one remote game server (RGS), the aggregation platform further operatively communicating with a Gaming Platform as a Service (GPAS), the at least one RGS and the GPAS hosting a plurality of games to be provided to a plurality of players through players' devices, wherein the aggregation platform comprising:
a feature shop unit, operatively communicating with the players' devices; and
a token and feature service unit;
wherein the GPAS further receiving from the aggregation platform data pertaining to tokens balance and/or Features balance, both associated with a player, and providing the data to the player,
wherein the tokens are usable by the player to acquire one or more Features from a list of available Features, wherein each of the Features has a respective predefined cost value in terms of a number of tokens, and wherein each Feature is operable in one or more of the plurality of games, depending on a Feature's stake value associated with the respective Feature, the method comprising:
by a processor of the aggregation platform, with respect to each player of the plurality of players:
by the token and feature service unit, associating the player with a tokens balance comprising one or more tokens and with a Features balance comprising one or more Features, the Features have been acquired by the player, wherein each Feature is associated with a respective Feature's stake value;
transmitting the associated tokens balance and the Features balance to the player, through the GPAS;
repeatedly monitoring operation of the player, including:
transmitting, by the feature shop unit, the list of available Features to be displayed at the player's device;
in response to receipt from the at least one RGS or the GPAS data on game events generated the plurality of games, continuously updating, by the token and feature service unit, the tokens balance according to a predefined configuration; wherein the updated tokens balance over a selected time interval or portion thereof constitutes a token balance trail;
receiving, by the feature shop unit, from the player's device, a selection of a Feature from the list of available Features, wherein the Feature is operable in at least one game of the plurality of games,
based on the selection, updating, by the token and feature service unit, the tokens balance, by degrading the number of Feature's cost value;
determining a Feature's stake value of the selected Feature, based on the tokens balance trail, and associate the selected Feature with the determined Feature's stake;
adding the selected Feature, by the token and feature service unit, to the Feature's balance, thereby enabling operation of the selected Feature, according to the feature's stake, and
transmits the updated Feature balance, by the feature shop unit, to the player's device.

11. A non-transitory computer readable storage medium tangibly embodying a program of instructions that, when executed by a computer, cause the computer to perform a method of operating an aggregation platform, comprising:
providing an aggregation platform operatively communicating with at least one remote game server (RGS), the aggregation platform further operatively communicating with a Gaming Platform as a Service (GPAS), the at least one RGS and the GPAS hosting a plurality of games to be provided to a plurality of players, the GPAS is further receiving from the aggregation platform data pertaining to tokens balance and/or one or more states, both associated with a player, and provides the data to the player,
wherein each of the states has a respective predefined value in terms of a number of tokens, and wherein each state is applied in one or more games of the plurality of games, based on a respective state's operational conditions, the method comprising:
by a processor of the aggregation platform, with respect to each player of the plurality of players:
associating the player with a tokens balance comprising one or more tokens;
associating the player with one or more states, based on the respective predefined value, and applying the one or more states in one or more games based on their respective state's operation conditions; and
repeatedly monitoring operation of the player, including:
in response to receipt from the at least one RGS or the GPAS data on game events generated in the plurality of games, continuously updating the tokens balance according to a predefined configuration, wherein the updated tokens balance over a selected time interval or portion thereof constitutes a token balance trail;
determining that the updated tokens balance reaching a predefined value of one or more of the states, thereby the one or more states constituting states-to-update;
determining respective state's operation conditions for each one of the states-to-update, based on the tokens balance trail, and associating each of the one or more states-to-update with the respective determined state's operation conditions; and
associating the player with the states-to-update.

12. A non-transitory computer readable storage medium tangibly embodying a program of instructions that, when executed by a computer, cause the computer to perform a method of operating one or more game Features, comprising:
providing an aggregation platform operatively communicating with one or more remote game servers (RGS) hosting a plurality of games to be provided to a plurality of players through players' devices,
wherein at least one RGS of the one or more RGS is a designated RGS receiving from the aggregation platform data pertaining to tokens balance and/or Features balance, both associated with a player, and to provide the data to the player,
wherein the tokens are usable by the player to acquire one or more Features from a list of available Features, wherein each of the Features has a respective predefined cost value in terms of a number of tokens, and wherein each Feature is operable in a game of the plurality of games, depending on a Feature's stake value associated with the respective Feature, the method comprising:
by a processor of the aggregation platform, with respect to each player of the plurality of players:
associating the player with a tokens balance comprising one or more tokens and with a Features balance comprising one or more Features, the Features have been acquired by the player, wherein each Feature is associated with a respective Feature's stake value;
transmitting the associated tokens balance and the Features balance to the player, through the designated RGS;
repeatedly monitoring operation of the player, including:
transmitting the list of available Features to be displayed at the player's device;
in response to receipt from the one or more remote game servers (RGS) data on game events generated in the plurality of games, continuously updating, the tokens balance according to a predefined configuration; wherein the updated tokens balance over a selected time interval or portion thereof constitutes a token balance trail;
receiving, from the player's device, a selection of a Feature from the list of available Features, wherein the Feature is operable in at least one game of the plurality of games,
based on the selection, updating, the tokens balance, by degrading the number of Feature's cost value;
determining a Feature's stake value of the selected Feature, based on the tokens balance trail, and associate the selected Feature with the determined Feature's stake;
adding the selected Feature, to the Feature's balance, thereby enabling operation of the selected Feature, according to the feature's stake.
